(19) United States
(12) Patent Application Publication
(10) Pub. No.: US 2021/0075697 A1
(43) Pub. Date: Mar. 11, 2021

(54) SELF-BALANCING NETWORK

(71) Applicant: Greenwave Systems PTE. LTD., Singapore (SG)

(72) Inventors: Siddhartha Dattagupta, Irvine, CA (US); Vaughn Rhodes, Ladera Ranch, CA (US); Thomas Cowling, Rolling Hills Estates, CA (US); Allan Dickow, Hillerod (DK)

(21) Appl. No.: 16/950,338

(22) Filed: Nov. 17, 2020

Related U.S. Application Data
(63) Continuation of application No. PCT/US2019/193419, filed on May 28, 2019.
(60) Provisional application No. 62/677,156, filed on May 28, 2018.

(51) Int. Cl. H04L 12/24; H04L 12/46; G06K 9/62; G06N 3/04

(52) U.S. Cl. CPC H04L 41/5009; H04L 41/0886; G06N 3/04; H04L 12/4633; G06K 9/6256; H04L 41/22

(57) ABSTRACT

A self-balancing network may be created by establishing a single control point for a software-defined network (SDN). The SDN includes one or more network slices and utilizes a first network segment using non-routable IP addresses, a second network segment using routable IP addresses, and a third network segment. A first device and a second device are added to a network slice of the one or more network slices of the SDN. The first device is coupled to the first network segment. A network policy is obtained as a part of a service-level agreement for the network slice and at least one of the first network segment, the second network segment, or the third network segment, is configured, by the single control point, to enforce the network policy for communication between the first device and the second device.

### CROSS-REFERENCE TO RELATED APPLICATIONS

This application is a continuation of International Patent Application PCT/2019/034191 filed May 28, 2019 which claims the benefit of U.S. Provisional Application 62/677,156 filed May 28, 2018, both of which are hereby incorporated by reference in their entirety herein for any and all purposes.

### BACKGROUND

### Technical Field

The present subject matter relates to computer networks and more specifically to balancing of an interlinked set of computer networks.

### Background Art

As the number of interconnected devices in a given installation increases, along with an increasing number of network segments using a variety of physical media and protocols to support those devices, those network segments need to be managed to allow the devices to access the network resource required for their operation. Non-limiting examples of local area networks (LANs) that are commonly used in home, office, and/or industrial environments include, but are not limited to, various versions of Ethernet (IEEE 802.3), various versions of Wi-Fi© (IEEE 802.11), and cellular networks such as 4G and 5G networks.

In most cases, networks utilize TCP/IP protocols for data communication and most LAN installations utilize non-routable IP addresses for devices on the LAN, which may then be referred to as a private network. A packet from a non-routable IP address cannot be routed through the public internet, but must be transformed to appear to come from a device with a routable IP address to be routed through the public internet. This means that the same non-routable IP addresses can be used repeatedly for private networks as long as the same IP address is not duplicated in a single private network. This also means that non-routable addresses can be used by anyone for a private network without the need to register a set of publicly routable IP addresses with a central authority to avoid duplication. The Internet Engineering Task Force (IETF) has defined several ranges of both IPv4 and IPv6 address space as non-routable IP addresses, including 10.0.0.0-10.255.255.255 and 192.168.0.0-192.168.255.255 in IPv4 address space, which are among the most commonly used non-routable IP addresses for large businesses and home/small business applications, respectively.

A variety of infrastructure networks, which may be referred to a wide-area networks (WANs), may be used to interconnect those LANs, which may collectively be referred to as the internet. WANs typically use routable IP addresses, and it is common for a private network (or LAN) to include a gateway device which provides a mechanism to allow packets from devices with a non-routable address to be routed through the public internet. The gateway device may include a first connection to the LAN which has a non-routable IP address and a second connection to a device outside of the LAN which has a routable IP address. In at least some cases, the gateway device may include a network address translation (NAT) function which can receive a packet from a local device, assign it to a particular port number of its routable IP address, and transmit the changed packet to a WAN as if it originated from the gateway device. The NAT function can also receive incoming packets from the WAN to that port number and translate them to the correct private IP address before forwarding them to the correct device on the LAN.

There are many well-known standards in the industry that define protocols that may be used for various tasks within networking systems. Some of them include IEEE 802.11k Radio Resource Management for Wireless LANs, IEEE 802.11r Fast Basic Service Set (BSS) Transition, IEEE 802.11v Wireless Network Management (all of which were merged into IEEE 802.11-2012 which is incorporated by reference herein), IEEE 802.1Q-2014 Bridges and Bridged Networks (which is incorporated by reference herein) which also describes the QinQ specification, IEEE 1905.1-2013 Standard for a Convergent Digital Home Network for Heterogeneous Technologies (which is also incorporated by reference herein) and the Wi-Fi Alliance Multi-AP Specification version 1.0 (which is incorporated by reference herein).

Some services defined by 802.11k include the following request/report pairs:
The beacon request/report pair enables a station (STA) to request from another STA a list of access points (APs) whose beacons it can receive on a specified channel or channels.
The frame request/report pair returns a picture of all the channel traffic and a count of all the frames received at the measuring STA.
The channel load request/report pair returns the channel utilization measurement as observed by the measuring STA.
The noise histogram request/report pair returns a power histogram measurement of non-IEEE 802.11 noise power by sampling the channel when virtual carrier sense indicates idle and the STA is neither transmitting nor receiving a frame.
The STA statistics request/report pair returns groups of values for STA counters and for basic service set (BSS) Average Access Delay. The STA counter group values include transmitted fragment counts, group addressed transmitted frame counts, failed counts, retry counts, multiple retry counts, frame duplicate counts, Request to Send (RTS) success counts, RTS failure counts, Acknowledgement (ACK) failure counts, received fragment counts, group addressed received frame counts, frame check sequence (FCS(error counts, and transmitted frame counts. BSS Average Access Delay group values include AP average access delay, average access delay for each access category, associated STA count, and channel utilization.
The location request/report pair returns a requested location in terms of latitude, longitude, and altitude.
The neighbor report request is sent to an AP, which returns a neighbor report containing information about known neighbor APs that are candidates for a service set transition.
The link measurement request/report exchange provides measurements of the RF characteristics of a STA-to-STA link. This measurement indicates the instantaneous quality of a link.
The Transmit Stream/Category measurement is a request/report pair that enables a quality of service (QoS) STA to inquire of a peer QoS STA the condition of an ongoing traffic stream between them.

IEEE 802.11r defines mechanisms for a STA to set up security and QoS parameters prior to re-association to a new AP. This allows time-consuming operations (e.g., cryptographic operations) to be removed from the time-critical re-association process.

Some services defined by 802.11v include:
BSS transition management which enables an AP to request non-AP STAs to transition to a specific AP, or to indicate to a non-AP STA a set of preferred APs, due to network load balancing or BSS termination.
Collocated interference reporting which enables the requesting STA to obtain information on interference due to collocated radios at the reporting STA. The requesting STA can use that information to schedule its transmissions to minimize the effects of the interference.
Diagnostic requests that enable a STA to request a non-AP STA to report on information that may be helpful in diagnosing and resolving problems with the wireless LAN (WLAN) network. Diagnostic reports include information on hardware, configuration, and STA capabilities.
Event requests that enable a STA to request a non-AP STA to send particular real-time event messages. The types of events include Transition, RSNA, WNM Log, and Peer-to-Peer Link events. A transition event is transmitted after a non-AP STA successfully completes a BSS Transition. Transition events are used to diagnose transition performance problems.
The Triggered STA Statistics reporting capability enables generation of a STA statistics report when the statistics of interest reach a predefined threshold.

The Wi-Fi Alliance Multi-AP Specification version 1.0 defines control protocols for use between Wi-Fi access points (APs) and also defines data objects that are used for onboarding, provisioning, control and management of the APs. The specification also provides mechanisms for routing of traffic between the APs of the multi-AP network.

As the term is used in the various IEEE 802.x standards, a Basic Service Set (BSS) is a set of devices that can communicate with each other at the physical link (PHY) level in a WLAN. If a BSS is serviced by an access point, is an infrastructure BSS.

Again, as the term is used in the various IEEE 802.x standards, an Extended Service Set (ESS) is a set of infrastructure BSSes (1 or more) which are included on a common logical network segment. This means that devices in the ESS appear to be on a single network to the logical link control layer. This allows stations within an ESS to communicate with one another, and mobile stations can easily move between BSSes within the ESS transparently to layer 2 resources (i.e. the link layer) of the network.

A software-defined network (SDN) is a term that is well-known in the industry. It refers to a technique to manage a network which uses software to control the various links of the network and separates the forwarding of the network data packets (i.e. the data plane) from the routing process (i.e. the control plane). The control plane can have one or more controllers distributed at various points in the network to manage the SDN.

Network slicing is another term commonly used in the industry. It allows multiple logical networks (i.e. slices) to run on a shared physical network. Each network slice can provide end-to-end characteristics to its tenants that can have very different characteristics between slices even though they are sharing the same physical network. Network slices are isolated from each other to allow different types of tenants to share the same physical network.

### BRIEF DESCRIPTION OF THE DRAWINGS

The accompanying drawings, which are incorporated in and constitute part of the specification, illustrate various embodiments. Together with the general description, the drawings serve to explain various principles. In the drawings:

FIG. 1 is a hardware block diagram of an embodiment of a system suitable for use as a self-balancing network;

FIG. 2 is a software block diagram of the embodiment of the system of FIG. 1;

FIG. 3 shows a flowchart of an embodiment of a method for self-balancing a network;

FIG. 4 shows a flowchart of an embodiment of a method to add a device to the self-balancing network;

FIG. 5 shows a flowchart of an embodiment of a method to use a quality of experience (QoE) calculation to balance the network;

FIG. 6 shows equations that may be useful for embodiments of calculating QoE;

FIG. 7 shows a flowchart of an embodiment of a method to use device behavior prediction to proactively balance the network; and

FIG. 8 shows a flowchart of an embodiment of a method to use network slice behavior prediction to proactively balance the network.

### DETAILED DESCRIPTION

In the following detailed description, numerous specific details are set forth by way of examples in order to provide a thorough understanding of the relevant teachings. However, it should be apparent to those skilled in the art that the present teachings may be practiced without such details. In other instances, well known methods, procedures and components have been described at a relatively high-level, without detail, in order to avoid unnecessarily obscuring aspects of the present concepts. A number of descriptive terms and phrases are used in describing the various embodiments of this disclosure. These descriptive terms and phrases are used to convey a generally agreed upon meaning to those skilled in the art unless a different definition is given in this specification. Some descriptive terms and phrases are presented in the following paragraphs for clarity.

A network segment, as the term is used herein, is a portion of the network that shares a common physical medium for communication. Two devices sharing a network segment can see traffic from other devices on the network segment and may be able to communicate with each other directly. A BSS is an example of a network segment.

The fronthaul, as the term is used herein, includes one or more network segments in an SDN between a device on a LAN (i.e. a device using a non-routable IP address) and a gateway device which can receive packets from the device with the non-routable IP address, convert them into a packet that can be routed, and send them over a network using a routable IP address.

The backhaul, as the term is used herein, includes one or more network segments in an SDN between a target device accessible through a WAN and a gateway which can receive packets from a device with a non-routable IP address on a LAN, convert them into a packet that can be routed, and send them over a network to the target device using a routable IP address.

A self-balancing network (SBN) is described herein which uses network slicing of a SDN to provide different slices with different service-level agreements (SLAs) using various systems and methods. A SLA can define various parameters (i.e. network policies) that define various aspects of the network for tenants of the slice, such as a minimum bandwidth, a quality of service (QoS), a maximum latency, or other parameters relative to computer network communication. The SDN may include any number of network segments that may provide for multiple routes through the SDN to a target device, such as a cloud-based server. The network segments can be any combination of network segments using any type of physical media (e.g. radio-frequency channels, optical fibers, or wires), any type of modulation technique, any network protocol, or other network characteristic. The SDN may include one or more network segments utilizing non-routable IP addresses and one or more network segments utilizing routable IP addresses.

The SBN provides a capacity-based balanced network topology for a tenant device that meets network policies set by a service level agreement for that device, such as quality of experience (QoE)/QoS requirements by providing routes through the SBN that meet those policies. The SBN may offer whole-home coverage in some embodiments with a balanced network capacity design of defined rate vs range (RvR). It may also be able to offer management of so-called managed, unmanaged, and semi-managed networks. It may also run continuous diagnostics and analytics to help trigger business rules, anomaly detection and remedial suggestions, non-intrusive/non-disruptive network balancing, and visualization of a current network state or proposed changes to the SBN.

The SBN can perform a variety of functions, depending on the embodiment, which may include, but are not limited to, spectrum management, fronthaul balancing, and backhaul balancing, and may utilize rules to achieve faster convergence of a balanced backhaul or a balanced fronthaul without disruption of current service. In some embodiments, the SBN provides a user interface and operations dashboard to configure, override, and use predictive learning through historical data to continuously improve the balancing. The SBN collects baseline data as a parametric reference and monitors the backhaul and fronthaul parameters. It can then create capacity and QoE metrics. Predictive patterns are used to compare the current metrics with the previous metrics and detect network anomalies to correct and rebalance the network.

The SBN creates a SDN control plane between the network controller, agents, and other SBN compliant devices. In some embodiments, a universal plug-and-play (UPnP) device management (DM2) data model may be used with SBN-defined device and configuration services defined by the SBN controller. A SBN controller may act as UPnP DM2 control point to use the device and configuration services to communicate with and control SBN Agents on other infrastructure nodes and end devices.

In some embodiments, extensions defined for IEEE 1905.1 type-length-value (TLV) data elements by the Wi-Fi Alliance Multi-AP specification are used to communicate between the SBN controller and SBN agent. Devices may be able to use those TLV SBN extensions to communicate higher level information to the controller. For example, a set-top box (STB) may inform the controller about the application session context, stream traffic specification (TSPEC) information, jitter buffer status, latency failures, buffer overruns and underruns, and the like. SBN vendor extensions are defined that can be put in 802.11 vendor information elements (IEs) that could be used for Wi-Fi Protected Setup (WPS) registrars and APs to decide on device steering logic.

The SBN controller may manage spectrum used by an AP in several different ways. The spectrum may be managed to control latency, packet error rate (PER), co-channel interference, signal-to-noise ratio (SNR), and other characteristic of the wireless network segment that may impact the QoE. The SBN controller may determine which channel to assign to a particular AP and what channel bandwidth to use, selecting between a 20 MHz, 40 MHz, 80 MHz, or 160 MHz bandwidth for the channel. Different channel bandwidths provide different data bandwidths and co-channel interference which may impact latency.

In some embodiments, the SBN controller may manage the configuration of infrastructure nodes such as APs, for example managing different APs and extenders to share or not share a specific frequency channel. The SBN controller may account for the multiple potential paths from source to destination and a number hops needed in its path generation and select optimum channel frequencies for each wireless infrastructure device. In some embodiments, network nodes may change channels based on associated stations, activities, and the like, which the SBN controller may also manage. The SBN controller may also monitor physical data rates on various network segments to detect the global and local noise through the station reports and make a decision on channel selection. The SBN controller may also manage dynamic frequency selection (DFS) of channels to allow wireless LANs (WLANs) to co-exist with radar systems in some embodiments.

Fronthaul balancing may be performed by the SBN controller. This may be accomplished through device steering; stations in a WLAN may be steered from one BSS to another to balance the capacity of the network. This may be done during onboarding when a new device (or STA in Wi-Fi terminology) is added to the network, or dynamically for devices already included in the network.

Steering during onboarding can be achieved through SBN rules applied to Wi-Fi Protected Setup (WPS) where a specific band is chosen for a specific type of device. The decision process can be governed by number of spatial streams (NSS), a 802.11k beacon report, an application profile (managed, unmanaged), or other information. Similar logic can also be applied to during re-association time of the device. The STA can provide the application profile information in a vendor specific IE during WPS or probe based association. If the STA has already done a background scan before doing WPS, then it can also provide the beacon report as a part of vendor IE to inform the WPS registrar to act accordingly.

For devices that are already added to a wireless segment, a decision may be made to switch it to a different wireless segment using a different AP, a different channel, or even a different frequency band if the device has multiple physical interfaces supporting that. Some systems may have the capability of steering the device from one interface to the other during runtime. In order to achieve this, the IP layer on the device may be virtualized to maintain the IP connectivity while the physical layer is changing.

If an end device is capable of connecting to two different network segments, the SBN may allow for predictive switching between the two interfaces. Since the capacity is defined per frequency and per access category with defined prioritization, the user can define the device priority and application priority based capacity assignment. For devices with higher priority or when a higher priority application runs on a device, the network links in the data path may receive the required capacity assignment as per the priority. For example, if a device operating on a particular 5 GHz channel begins to experience lower capacity than its SLA promises, a lower priority device on the same 5 GHz link channel may be steered to a different band in the SBN.

No standard mechanism exists to allow a device to indicate that it supports two different physical network connections to the SBN controller, so an SBN controller may include the capability to learn which physical interfaces are included in a particular device and store this information for future use in a database or other data structure. The SBN controller may track devices on each network segment and maintain its own internal database of devices currently associated, and devices previously associated with different network segments even if they are no longer currently present. The database may use the MAC address of the station to index this information. When a device attempts access to a network segment of an AP or other infrastructure device, the SBN controller is informed by the AP. The SBN controller may then store the information that the device can support the particular type of network used by that network segment for later use and decide whether or not to allow the device to join that network segment. The SBN controller has responsibility for allowing or preventing a device access to a network segment in the SDN. In case a device is seen for the first time (i.e. there is no database entry for the device), the access may be allowed, and a new database entry created. The database may be non-volatile, holding the information across system reset and/or power cycles because learning about the capabilities of a particular device, such as dual-band capability, has to rely upon historical information. If storage is limited, then oldest entries may be discarded.

A decision of whether to accept a Wi-Fi client in a certain band may depend in part on historical information available about that device, but it also may consider real-time events. For example, a station that consistently keeps coming back to the same frequency band, may be doing so because it does not have the capability to connect to a different frequency band, or because it is has been programmed to always use that frequency band, so it may need to be added to that band to be able to connect to the SDN at all.

There may be two aspects to band steering or location steering. The first aspect is a policy decision as to whether or not to perform the steering and the second aspect is the mechanics of how to make the decision as to where to steer the device. Typical inputs to the policy decision include, but are not limited to, bandwidth utilization of the current band, a received signal strength indicator (RSSI), a physical data rate on the network segment, and whether to do load balancing of devices using a band or between infrastructure devices. The policy decision may also determine which devices may be steered to a different frequency band or infrastructure device. This situation of having multiple devices that could potentially be band or location steered can happen if the policy decision is based on load-balancing, for example. One possible way of deciding which device(s) to steer could be a ranking of the devices based on a measure that is calculated based on various parameters such as bandwidth, RSSI, PHY rate, where particular weights are associated with each of those parameters.

Once a decision to steer is made, different techniques may be used to achieve the steering. While any technique may be used to move/steer a device, some embodiments may de-authorize a station on its current network segment, forcing it to connect to a different network segment. Other embodiments, may withholding a probe response, such as when dual band station sends simultaneous probes to both bands. Yet other embodiments may use BSS transition commands defined by 802.11v. The steering of devices may be between bands with the same ESS within one single SBN infrastructure node, between bands with the same ESS across different SBN infrastructure nodes, between bands with different ESS within one single SBN infrastructure node, or between bands with different ESS across different SBN infrastructure nodes.

The SBN controller may also perform backhaul balancing to the infrastructure devices utilized by the SDN. This includes gateways, routers, access points, and network extenders/repeaters. This balancing is governed by an attempt to optimize spectrum management and maximize stable network capacity for a dynamic mix of device capabilities, locations, and network loading, as well as different capabilities of the network segments used in the backhaul. The SLA network polies related to end to end latency and bandwidth requirements also come into play. The SBN attempts to organize the various network segments in a topology to achieve the best possible capacity for all end devices connected to the SDN given the physical constraints of the various network segments and their physical connectivity.

SBN infrastructure nodes may be balanced during onboarding and addition of those nodes to the backhaul. For example, WPS-based onboarding rules may be applied similarly to adding new devices to LANs may be used.

The balancing of the backhaul may be performed in response to the addition of a new end device to the SDN, in response to the addition of a new infrastructure device to the SDN, in response to a detected change in one or more network segments in the SDN, or in response to a predicted change in one or more network segments in the SDN, among other reasons. When a new device is added to the network with an end to end service profile requirement it may be associated to the nearest node based on the best RSSI value. However, the end to end data stream could experience higher latency or error rates based on the location of the source in the network, so based on the traffic profile and associated devices, the backhaul may be rebalanced to attempt to meet the SLA network policies for connected devices. When a new infrastructure node is added to the network a first degree balancing may be done based on the best stable capacity over the backhaul.

The SBN controller may monitor both fronthaul capacity and QoE and backhaul capacity and QoE to find if the topology needs a change to continue to enforce the network policies for the network slice In addition, any change to the network polices due to explicit or implicit changes made by users or administrators may also cause backhaul re-balancing.

The SBN may be used to provide a particular set of services delivered at a particular minimum quality of experience (QoE) for a customer. This may be thought of as using business-driven intents (what is to be delivered to a customer) to drive a service level agreement (SLA) for a particular service, such as whole-home wireless internet, internet protocol television (IPTV), home automation using internet of things (IoT) devices, or any other service utilizing internet functionality. An SLA may then be enforced using a network slice of a software defined network (SDN) with compatible configurations which may be managed as a self-balancing network (SBN) by an SBN controller. Network slices may be orchestrated and deployed through the SBN controller; either locally in customer premises equipment (CPE) or in a virtual CPE environment. The SBN controller may move devices between network slices in conformance with SLA guarantees and network slices may be configured on the fly as the SLA and business needs change.

In some embodiments, a network subscriber's usage pattern of network and devices are mapped into an intent and a predictive intent model is created to predict the movement of devices and usage of network. A capacity forecast may be done based on subscriber's intent and the SDN pre-balanced to support an end to end capacity as per the SLA. Network devices may move between fixed and mobile networks based on user action or movement as well as under control of the SBN controller. The SBN controller may facilitate seamless handover of the device between network segments providing both continuous connectivity and maintain the SLA by extending the network slice across the fixed and mobile networks seamlessly to guarantee services across the networks. The SBN controller balances wired, wireless mobile and fixed WLAN networks used for the end-to-end communication based on the SLA for the network slice and based on a device's attachment to a particular network segment.

A user's intent may be inferred based the observed behavior of the user's device over time. The observed behavior may include physical movement between fixed networks, movement between fixed WLANs and mobile wireless connections (e.g. cellular networks), changes in bandwidth usage, times that the device is disconnected from any network, physical location of the device, or any other observable parameter related to the device.

Some SLAs may promise whole home coverage and/or guaranteed service delivery. But in a probabilistic network like Wi-Fi, the network capacity is difficult to confirm. This becomes even more difficult when more and more nodes get introduced to the network with a mix of managed, unmanaged and semi-managed devices and nodes. Maintaining a good topology to provide a maximum stable capacity with the right level of QoE may require continuous analytics, meaningful data collection, accurate analysis of collected data, and insightful decision making. The network may be to be defined as a second order system with correct set of rules in order to converge on a topology of network links and to provide the maximum stable capacity without service disruption.

Conventional solutions try to maximize the network speed without considering the overall system view. The SBN controller provides a maximum stable capacity which could be lower than a theoretical maximum but offers stable predictable service guarantees. This solution also takes care of virtual segmentation of managed, un-managed and semi-managed networks.

In some embodiments, information from the SBN controller may be used offer a higher level of service to a customer. Other business models may also be supported to allow one customer to provide their unused capacity for a period of time to another user in exchange for additional capacity at some time in the future or for financial consideration. The information available from the SBN controller may be useful for the service provider to customize their offering to the user's actual needs, rather than pushing them into a predetermined bucket of services.

Reference now is made in detail to the examples illustrated in the accompanying drawings and discussed below.

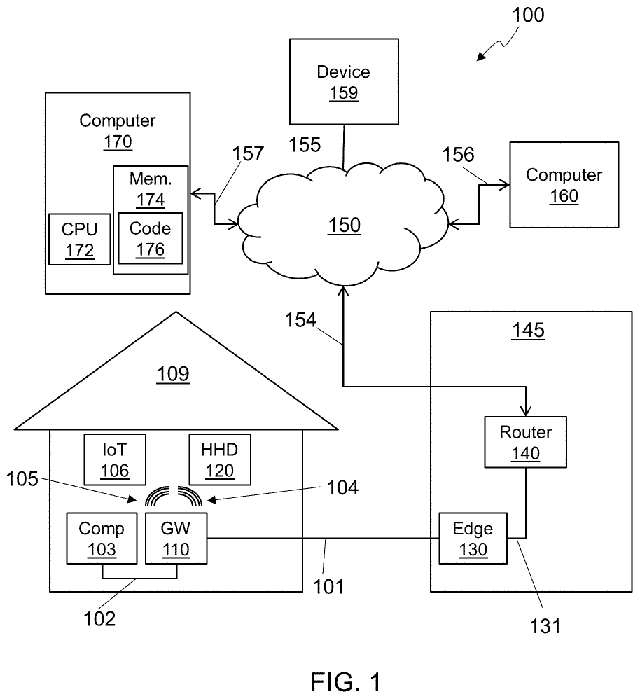

FIG. 1 is a hardware block diagram of an embodiment of a system 100 suitable for use as a self-balancing network. The system 100 includes a home 109, which could also represent a small business, enterprise business, industrial building/campus, or other institution or building. The home 109 includes a connection 101 to provide internet access to the home 109 which is coupled to a gateway device 110 providing a local ethernet network segment 102. The gateway 110 in this embodiment is also an access point providing two wireless networks, a 2.4 GHz network 105 and a 5 GHz network 104. Many other configurations are well known in the industry and may be appropriate for other embodiments, including having a modem separate from the gateway 110 and/or having separate access points, switches, routers, and/or other network equipment providing one or more network segments for use within the home 109.

The home 109 may include any number of any type of networking device but only three are shown in FIG. 1. A computer 103 is coupled to the ethernet network segment 102, an internet-of-things (IoT) device 106 is coupled to the 2.4 GHz wireless network 105, and a handheld device (HHD) 120 such as a smartphone is coupled to the 5 GHz network 104.

The connection 101 is provided by an edge device 130 of the internet service provider, which may be housed in a central office (CO) 145. The edge device 130 may provide any type of connection 101, including, but not limited to, a digital subscriber line (DSL) on a standard telephony wire pair 101, a coaxial cable connection 101 providing data compliant with data over cable service internet specification (DOCSIS), or an optical fiber connection 101 for a gigabit-capable passive optical network (GPON). The edge device 130 may be coupled to a router 140 by network segment 131 which may be coupled through network segment 154 to the internet 150.

The internet 150 may provide connection to millions of devices, but three are shown in FIG. 1 as representative devices. A device 159 is coupled to the internet 150 by network segment 155, a computer 160 is coupled to the internet 150 through network segment 156, and another computer 170 is coupled to the internet 150 by network segment 157. The computer 170 includes a CPU 172 coupled to a memory 174, which may be referred to as a non-transitory machine readable medium. The memory 174 may be any type of memory or combination of types of memory, including, but not limited to, dynamic random access memory (DRAM), double data-rate DRAM (DDR), read-only memory (ROM), NAND or NOR flash memory, a rotating-media hard drive, an optical storage media, or any other type of computer readable media capable of storing data that can be accessed by the CPU 172. The memory 174 stores one or more instructions 176 that in response to being executed on a computing device 170 cause the computing device 170 to carry out a method as described herein.

A SBN controller may perform a method of creating a self-balancing network using the system 100. The method establishes a single control point for a software-defined network (SDN) that includes one or more network slices. The SBN controller may execute in any of several different computing devices of system 100, including, but not necessarily limited to, the computer 170, the computer 160, the router 140, the edge device 130, the gateway 110, the computer 103, the IoT device 106, or the handheld device 120. The SBN controller performing the self-balancing of a network slice may be included in any device that is a part of the SDN.

The SDN may utilize a first network segment 104 using non-routable IP addresses, a second network segment using routable IP addresses, such as, but not limited to, network segment 154, and a third network segment, which can be any other network segment utilized by the SDN, independent of the type of routing information used by that networking segment. The SDN may add a first device 120 and a second device 160 to a network slice of the one or more network slices of the SDN. The first device 120 is coupled to the first network segment 104.

The SBN controller then obtains a network policy as a part of a service-level agreement for the network slice and configures at least one of the first network segment 104, the second network segment 154, or the third network segment, to enforce the network policy for communication between the first device 120 and the second device 160. While the second device may be any device within the SDN that is included in the network slice, the computer 160 is used as an example of the second device. The computer 160 may be located within the CO 145 or may be elsewhere accessible through the internet 150. In some embodiments, the computer 160 may reside on a network segment that utilizes routable IP addresses but in other embodiments, the computer 160 may reside on a private network using non-routable IP addresses that is coupled to the internet 150 using a gateway device. In the example shown, the route from the HIHD 120 to the computer 160 utilizes the wireless network segment 104 which uses non-routable IP addresses, the connection 101, and network segments 131, 154, 156 which use routable IP addresses. Thus configuring the network slice may include configuring both the second network segment 154 and the first network segment 104 to enforce the network policy for communication between the first device 120 and the second device 160. It may also or alternatively include configuring the first network segment 104 and the third network segment 156 to enforce the network policy for communication between the first device 120 and the second device 160 where the second device 160 is coupled to the third network segment 156 and the communication between the first device 120 and the second device 160 also traverses the third network segment 156.

Alternatively, a wireless extender could be used to couple the HHD 120 to the gateway 110 where the first network segment is the link between the HHD 120 and the wireless extender and the third network segment is the link between the wireless extender and the gateway 110. In this embodiment, both the first network segment and the third network segment are coupled to a first port of a gateway device 110, and the second network segment 154 is coupled to a second port of the gateway device 110 through router 140, network segment 131, edge device 130, and connection 101.

In embodiments the SBN controller may receive an indication that the network policy can no longer be enforced for the first device 120 coupled to the first network segment 104. In some embodiments, the first device 120 may have access to a third network segment, such as another wireless network segment 105. The SBN controller may respond to the indication that the network policy can no longer be enforced by moving the first device 120, which is directly connected to the first network segment 104, to the third network segment 105. The first device 120 may include a virtualized IP layer to maintain IP connectivity during said moving. In embodiments, where a third device 106 is also connected to the first network segment 104, the SBN controller may respond to the indication that the network policy cannot be enforced for the first device by moving the third device 106 to the third network segment 105.

In some cases a single physical interface (PHY) may be able to access both the first network segment 104 and the third network segment 105, but in other cases, the first device 120 may have a first PHY supporting the first network segment 104 and a second PHY, different than the first PHY, supporting the third network segment 105. The first network segment 104 may include a first wireless network operating with a first carrier frequency and the third network segment 105 may include a second wireless network operating at a second carrier frequency. Any combination of the first network segment 104 and third network segment 105 hosted by a common or separate access point devices and being in a common or separate extended service sets (ESSes) may be supported, including the first network segment 104 and the third network 105 segment both within a common extended service set hosted by a single access point device 110, the first network segment 104 and the third network segment 105 both within a common extended service set but hosted by two separate access point devices, the first network segment 104 and the third network segment 105 in two different extended service sets hosted by a single access point device 110, and the first network segment 104 and the third network segment 105 in two different extended service sets hosted by two separate access point devices.

In embodiments, the SBN controller may determine that the network slice is unbalanced due to one or more backhaul network segments utilized by the network slice for the communication between the first device 120 and the second device 160. The SBN controller may then determine that one or more backhaul network segments should be reconfigured to support the network policy for the first device 120. The one or more backhaul network segments, which include the second network segment 154, are coupled to a first port of a gateway device 110, and a second port of the gateway device 110 is coupled to both the first network segment 104 and the first device 120.

In some embodiments, the SBN controller may use a location of a device, or a predicted location of a device to manage the network slice. In some embodiments bandwidth allocation to a device may be based on measurement taken of network segment activity by one or more devices, such as the gateway 110, the edge device 130, or the router 140. The bandwidth usage may be based on a stochastic and/or statistical analysis. In some embodiments, the handheld device 120 may have location services enabled that allow it to report its location to the SBN controller so that when a user leaves home 109 with their handheld device 120, the SBN controller knows that the handheld device 120 will no longer be using the wireless network segment 104 and can configure the gateway 110 accordingly. The handheld device 120 may also have an app that allows the user to enter information, such as inputting a Home/Away mode which can be reported to the SBN controller which can then make appropriate configuration changes. In some embodiments, the SBN controller may also have control over the new network where the handheld device 120 next attempts to connect, and the SBN controller may be able to continue to include the handheld device 120 in the same network slice from the new network segment.

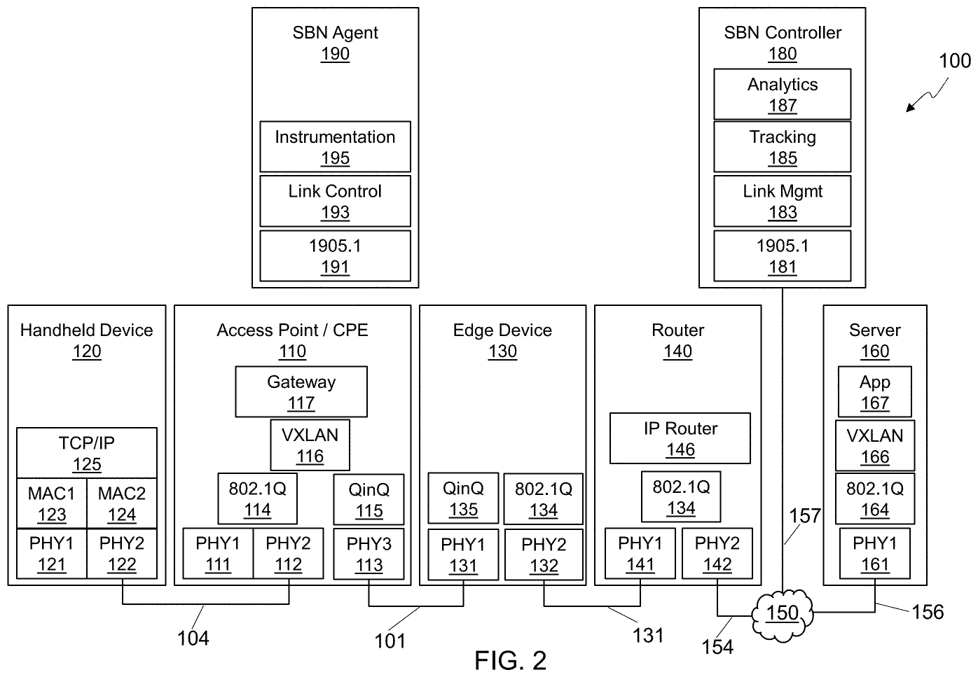

FIG. 2 is a software block diagram of the embodiment of the system 100 of FIG. 1. Not every element of FIG. 1 is shown in FIG. 2, and different detail is shown for the common elements that are shown. The handheld device 120 is communicating to the server 160 through a network slice that includes several network segments, 104, 101, 131, 154, 156, 157. The handheld device 120 includes a first network stack to communicate with a first type of network segment, such as a 2.4 GHz wireless network. The first network stack includes a first PHY layer 121 with a first MAC layer 123 and the second network stack includes a second PHY layer 122 with a second MAC layer 124. Both network stacks share a virtualized IP layer 125 to maintain IP connectivity if the device 120 is moved between the two network segments.

The access point (AP) or customer premises equipment (CPE) 110 includes a first PHY 111 to host the first type of network segment and a second PHY 112 to host the second type of network segment. Additional layers of the network stacks for the two network segments are not shown, but may be included in the AP/CPE 110. The AP/CPE 110 may also include 802.1Q functionality 114 to support virtual LANs. In some embodiments, the AP/CPE 110 may include the ability to create a virtual extensible LAN (VXLAN) which can create a virtual LAN across a variety of network segments that can then be used by the SBN controller to support its network slices. The AP/CPE 110 includes a third PHY 113 to support the connection 101 to the internet service provider's edge device 130, and has a QinQ function 115 to provide a layer 2 underlay tunnel to the edge device 130 to extend a broadcast layer 2 domain through the connection 101. The AP/CPE 110 also includes a gateway function 117, such as a network address translation (NAT) function, which allows packets using non-routable IP addresses on the first network segment 104 to be routable over the public internet 150.

The edge device 130 includes a first PHY 131 for the connection 101 and a second PHY 132 to connect to another network segment 131. The edge device includes a QinQ function 135 to create the layer 2 underlay coupling the first network segment 104 to the second network segment 131 on the connection 101 and a 802.1Q function to provide to support virtual LANs. Other underlay tunnels may be supported by the edge device 130 and AP/CPT 110, including IPSec, GRE, or L2TPv2 tunnels, in various embodiments.

The router 140 provides layer 3 or layer 4 routing/switching functionality 146 and includes a PHY 141 for a first port and a PHY 142 for a second port. It also includes 802.1Q 134 to support virtual LAN functionality.

The server 160 may be the destination of communication by the handheld device 120. It includes a PHY 161 to communicate with network segment 156, 802.1Q functionality 164 and may include VXLAN functionality 166. The server 160 may also include a software application 167 that can provide services for the handheld device 120. In some embodiments, a virtual extensible LAN overlay is created for the network slice between the server 160 and the AP/CPE 110. This may be referred to as a layer 2.5 network.

The SBN controller 180 may be hosted on any device of the SDN, including the computer 170. The host of the SBN controller 180 may be on a private network segment in the SDN utilizing a non-routable IP address, or a wide-area network (WAN) network segment 157 utilizing a routable IP address, depending on the embodiment. The SBN controller 180 may include an IEEE 1905.1 module 181 to provide simple setup, configuration and operation of the different network segments as well as a link management module 183 to manage assignment of different network segments to network slices, a tracking module 185 to monitor activity of the different network segments in the network slice, and it may include an analytic module 187 to analyze the behavior of devices in the network slice or the behavior of the network slice itself.

The SBN control 180 communicates with one or more SBN agents 190. Any device in the SDN may include an SBN agent 190, including the handheld device 120, the AP/CPE 110, the edge device 130, the router 140, and the server 160. The SBN agent 190 includes an IEEE 1905.1 module 191, a link control module 193 to provide control of a network segment, and may include instrumentation 195 to help monitor activity of a network segment.

Thus in an embodiment, the first network segment 104 may be a wireless network hosted by an access point device 110 which is not directly connected to the second network segment 154. Network segments of a network slice may be configuring by sending a command to the access point 110 over the second network segment 154 using an IEEE 1905.1 protocol.

Aspects of various embodiments are described with reference to flowchart illustrations and/or block diagrams of methods, apparatus, systems, and computer program products according to various embodiments disclosed herein. It will be understood that various blocks of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks. The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and/or block diagrams in the figures help to illustrate the architecture, functionality, and operation of possible implementations of systems, methods and computer program products of various embodiments. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

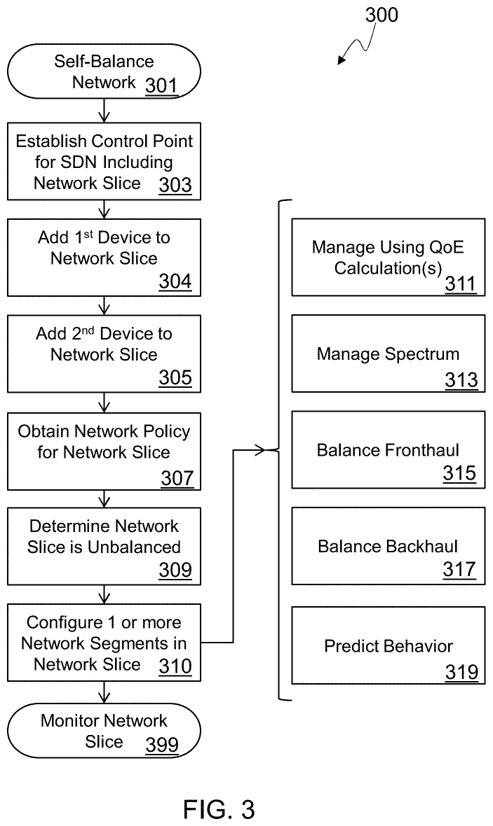

FIG. 3 shows a flowchart 300 of an embodiment of a method for self-balancing a network. A self-balancing network (SBN) is created 301 by establishing 303 a single control point for a software-defined network (SDN). The SDN includes one or more network slices and utilizes a first network segment using non-routable IP addresses, a second network segment using routable IP addresses, and a third network segment. Other network segments may be included in other embodiments using routable or non-routable IP addresses or network segments that do not utilize an IP address at all, but utilize other mechanisms to control routing of data such as a media access controller (MAC) address or some other identifying characteristic of the device connected to the network segment.

The flowchart 300 continues with adding 304 a first device to a network slice of the one or more network slices of the SDN. The first device is coupled to the first network segment. A second device is also added 305 to the network slice. Depending on the embodiment, the second device may be anywhere in the SDN, and may be connected to a network segment that utilizes a routable IP address, a non-routable IP address, or some other type of routing mechanism. In some embodiments, the second device may be on the third network segment.

A network policy is obtained 307 as a part of a service-level agreement for the network slice. The obtaining 307 may be performed by accessing data stored in memory, such as a database, or may be entered by a system administrator, end-user, or other individual or agent (human or computer) for the network slice. In some embodiments, the network policy may be a change to a previous network policy that may cause the self-balancing network to rebalance itself.

The SBN may determine 309 that the network slice is unbalanced and configure 310 one or more network segments in the network slice based on the determination. The determination may occur in response to any event or predicted event, such as, but not limited to, a change in the network policy, a change in a behavior of a device included in the network slice, or a change in the behavior of a network segment utilized by the network slice itself, such as an increased load on the network segment or a physical change in the topology of the network. The determining 309 that the network slice is unbalanced may include receiving an indication that the network policy cannot be enforced for the first device in some embodiments. The configuring 310 by the single control point may be done to at least one of the first network segment, the second network segment, or the third network segment, to enforce the network policy for communication between the first device and the second device before the SBN controller returns to monitoring 399 the network slice.

The configuring 310 may be performed based on one or more of using QoE calculations 311, spectrum management 313 of wireless networks utilized by the network slice, fronthaul balancing 315, or backhaul balancing 317. The configuring 310 may also be done based on predicting 319 behavior of a device or a network segment. Using QoE calculations 311, managing spectrum 313, fronthaul balancing 315, backhaul balancing 317, and predicting behavior 319 are discussed in more detail elsewhere in this document. In embodiments, the fronthaul includes one or more fronthaul network segments, including the first network segment, accessible for communication between the first device and a gateway device coupled between the first network segment and the second network segment. Conversely, the backhaul includes one more backhaul network segments, including the second network segment, accessible for communication between the second device and the gateway device.

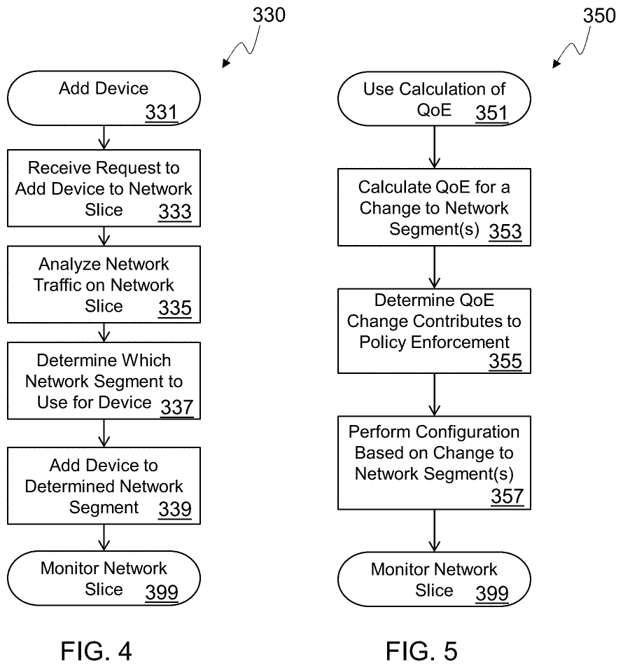

FIG. 4 shows a flowchart 330 of an embodiment of a method to add a device to the self-balancing network. The method to add a device 331 includes receiving a request 333 to add a third device to the network slice. In embodiments, the third device may have a capability to connect one of two or more network segments utilized by the network slice, such as the first network segment and the third network segment. In some embodiments, the two network segments be of the same type and utilize the same PHY within the device, but in other embodiments, the device may incorporate two different PHYs allowing it to be connected to two different types of network segments. The SBN controller may use various techniques to determine this, such as noting that the third device has previously been added to different types of networks in the past, or by previous communication with the device to discover its capabilities.

The SBN controller may analyze 335 network traffic on the network slice. The analyzing may utilize instrumentation built into various network components for the various network segments and, in some embodiments, may use information gathered using proprietary communication mechanisms or standards-based communication protocols such as IEEE 802.11k or IEEE 802.11v. The SBN controller may then determine 337 where the SBN can best accommodate the third device to enforce the network policy for the network slice, such as by determining 337 which of the first network segment and third network segment to utilize for the third device based on the network policy and said analyzing. Once the proper network segment has been determined, the third device may be added 339 to the determined network segment before the SBN controller returns to monitoring the network slice 399.

FIG. 5 shows a flowchart 350 of an embodiment of a method to use a quality of experience (QoE) calculation to balance the network. The QoE calculation method starts 351 by calculating 353 a QoE for a change that could be made to one or more network segments, such as calculating 353 a change to a first QoE calculation based on a particular change to a configuration of the third network segment. In other embodiments, this may include calculating 353 a change to the first QoE calculation or a second QoE calculation based on a particular change to a configuration of the first network segment.

The flowchart 350 then continues with determining that the change to the QoE calculation, or the second QoE calculation (if calculated), contributes to enforcing the network policy for communication between the first device and the second device. If so, the configuration of the third network segment may be performed 357 based on the particular change before the SBN continues to monitor the network slice 399. Thus, the determining that the network slice is unbalanced may be based on a QoE calculation and the configuring may be based on a QoE calculation for the network slice.

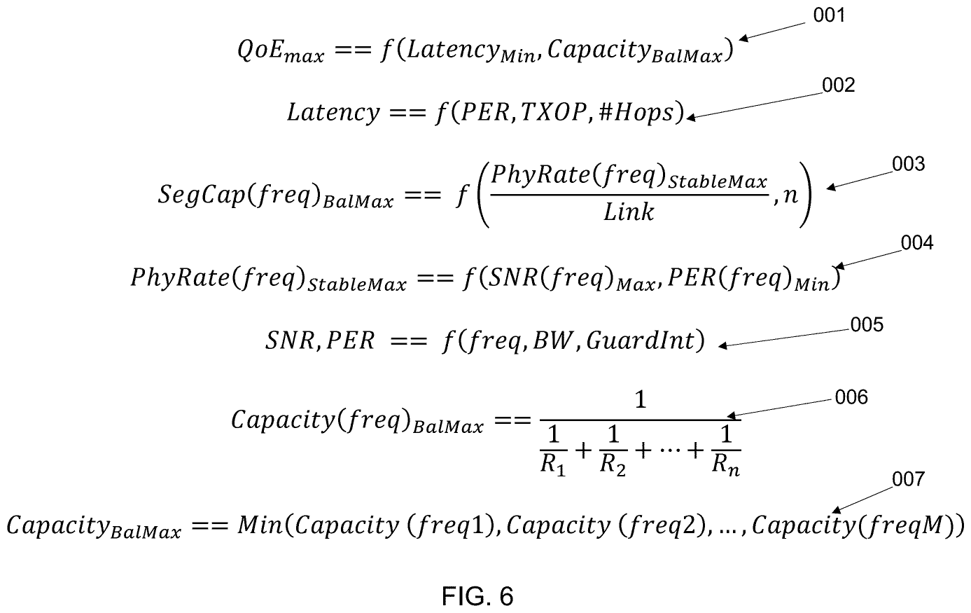

FIG. 6 shows equations 001-007 that may be useful for embodiments of calculating QoE. The equations 001-007 show variables used for the various equations, but the details of the equation 001-007 may vary between embodiments. A simple linear equation using various weights for the variables may be used in some embodiments, with the weights selected based on the network policy, types of network segments utilized, or other factors. In at least one embodiment, an equal weighting of a normalized range of values for each variable may be used for equation 001 through equation 005, although many other functions may be used for other embodiments.

Equation 001 shows a high-level calculation of a maximum QoE (QoEₘₐₓ) that may be obtained based on a minimum value of latency for a device (Latencyₘₐₓ) and a maximum bandwidth available for the device (Capacity_{BalMax}). Other embodiments may calculate QoE based on other variables, but as the latency for a device decreases, and/or a bandwidth available for a device increases, the QoE for that device will increase.

Equation 002 shows that latency (Latency) is a function of a packet error rate (PER), a number of transmit opportunities (TXOP), and a number of hops (#Hops) required for the end-to-end transmission. Other embodiments may calculate a predicted latency using other variables. In general, however, latency increases as the packet error rate increases which forces more retries, and as the number of hops (i.e. the number of network segments traversed) increases. Conversely, as the number or transmission opportunities increases, the latency decreases.

Equation 003 shows how balanced effective bandwidth (SegCap_{BalMax}) for a wireless network segment using a particular carrier frequency (freq) may be calculated. The effective bandwidth is a function of the physical data rate for a link of that network segment (PhyRate_{StableMax}/Link) at that frequency, and a number of connections between a device and an access point (n) at that frequency. So a network segment that has higher native data transfer rates will provide higher bandwidth for a device, but as more devices share that network segment, the bandwidth actually available to the device decreases. Equation 004 shows that the effective bandwidth of a network segment is based on a maximum signal-to-noise ratio (SNR_{Max}) for a frequency and the minimum packet error rate (PER_{Min}) for that frequency. Equation 005 shows that both the signal-to-noise ratio and the packet error rate are a function of the carrier frequency, a frequency band available to the channel used by the network segment (BW), and a guard interval between channels (GuardInt). Even for a higher received signal strength indicator (RSSI), a higher noise floor could result in a lower signal-to-noise ratio which can cause higher error rates at the receiver and would force the modulation and coding set (MCS) rates for the wireless network segment to adapt more aggressively and potentially could cause fluctuations on the MCS rates, reducing the effective physical data rate. Packet error rate is dependent on co-channel and on-channel interference which could cause collisions. Also, larger band sizes and smaller guard intervals may result in more interference increasing error rates.

The effective bandwidth for the end-to-end communication by the device using a particular wireless network also depends on the route used beyond that wireless network to the destination. Equation 006 shows that that the end-to-end bandwidth available for a connection to a particular network segment by a device depends on the effective capacity of a combination of the bandwidth of a number (n) of routes (R) available for use to the destination from that network segment. A wireless network segment operates in one single band of frequency. So even if multiple SBN enabled access points or repeaters are available on that channel, the effective bandwidth through the segment cannot exceed the bandwidth available for that channel as described in equation 003. This caps the total bandwidth when using that network segment as shown in equation 006.

The total effective bandwidth for communication between a source device and a target device can be defined, as shown in equation 007, as the minimum capacity available from any of the network segments used for the communication between the source and the target.

A balanced bandwidth does not necessarily mean the highest bandwidth. It means the maximum bandwidth (or capacity) that is sustainable for a given criteria of minimum rate fluctuations, minimum error rates, and the like. Latency and balanced bandwidth are significant contributors to QoE. For example, in a TCP-based system, the round-trip time and packet error rate significantly affect the overall throughput of the system. A continuous fluctuation the available bandwidth could cause TCP rate adaptation which could cause video delivery system to use a lower video profile. UDP-based systems, including multicast UDP-based systems, are sensitive to latency as well, as latency causes jitter which makes it harder to define the jitter buffer.

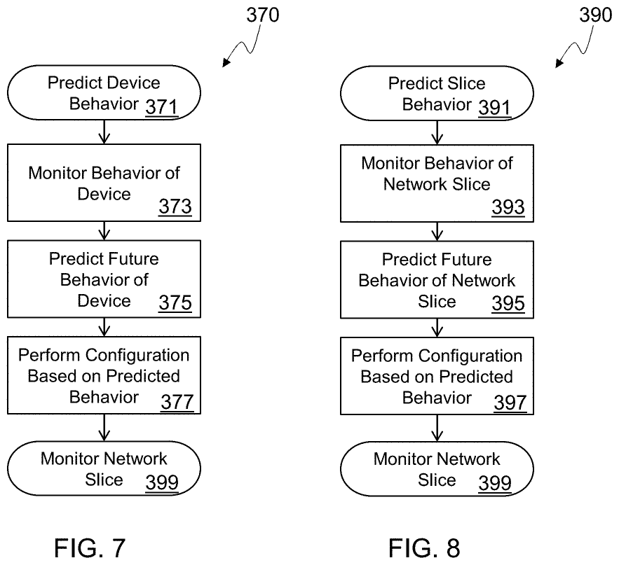

FIG. 7 shows a flowchart 370 of an embodiment of a method to use device behavior prediction to proactively balance the network. The method starts 371 by monitoring 373 behavior of the first device over time. It can then predict 375 a future behavior of the first device based on the monitored behavior. Examples of future behavior that may be predicted include, but are not limited to, a movement of the first device from the first network segment to a third network segment or a change in bandwidth used by the first device. Any technique or algorithm may be used to predict the future behavior based on past behavior, including, but not limited to using an analytic model, machine learning, or a trained neural network. In some embodiments, the predicting may be performed using an input to a user interface of the first device by a user. Once the future behavior is predicted, a configuration of the SDN may be determined to ensure that the network policy for the network slice is enforced for the first device, and one or more network segments utilized by the network slice configured 377 before the SBN controller returns to monitoring the network slice 399. Thus, the configuring may be based on the future behavior.

FIG. 8 shows a flowchart 390 of an embodiment of a method to use network slice behavior prediction to proactively balance the network. The method starts 391 by monitoring 393 behavior of the network slice over time. Monitoring the network slice may include monitoring one or more network slices utilized by the network slice. Embodiments may perform the monitoring by any mechanism, but in some embodiments, IEEE 802.11k or IEEE 802.11v may be used to monitor network segments. The SBN controller can then predict 395 a future behavior of the network slice based on the monitored behavior. Examples of future behavior that may be predicted include, but are not limited to, changes to bandwidth, latency, signal-to-noise ratio, error rates, or any other network parameter, some of which may be based on factors unrelated to activity of the network slice itself in some cases. Any technique or algorithm may be used to predict the future behavior based on past behavior, including, but not limited to using an analytic model, machine learning, or a trained neural network. Once the future behavior is predicted, a configuration of the SDN may be determined to ensure that the network policy for the network slice is enforced for the first device, and one or more network segments utilized by the network slice configured 397 before the SBN controller returns to monitoring the network slice 399. Thus, the configuring may be based on the future behavior.

As will be appreciated by those of ordinary skill in the art, aspects of the various embodiments may be embodied as a system, device, method, or computer program product apparatus. Accordingly, elements of the present disclosure may take the form of an entirely hardware embodiment, an entirely software embodiment (including firmware, resident software, micro-code, or the like) or an embodiment combining software and hardware aspects that may all generally be referred to herein as a “server,” “circuit,” “module,” client,” “computer,” “logic,” or “system,” or other terms. Furthermore, aspects of the various embodiments may take the form of a computer program product embodied in one or more computer-readable medium(s) having computer program code stored thereon.

Any combination of one or more computer-readable storage medium(s) may be utilized. A computer-readable storage medium may be embodied as, for example, an electronic, magnetic, optical, electromagnetic, infrared, or semiconductor system, apparatus, or device, or other like storage devices known to those of ordinary skill in the art, or any suitable combination of computer-readable storage mediums described herein. In the context of this document, a computer-readable storage medium may be any tangible medium that can contain, or store a program and/or data for use by or in connection with an instruction execution system, apparatus, or device. Even if the data in the computer-readable storage medium requires action to maintain the storage of data, such as in a traditional semiconductor-based dynamic random access memory, the data storage in a computer-readable storage medium can be considered to be non-transitory. A computer data transmission medium, such as a transmission line, a coaxial cable, a radio-frequency carrier, and the like, may also be able to store data, although any data storage in a data transmission medium can be said to be transitory storage. Nonetheless, a computer-readable storage medium, as the term is used herein, does not include a computer data transmission medium.

Computer program code for carrying out operations for aspects of various embodiments may be written in any combination of one or more programming languages, including object oriented programming languages such as Java, Python, C++, or the like, conventional procedural programming languages, such as the “C” programming language or similar programming languages, or low-level computer languages, such as assembly language or microcode. The computer program code if loaded onto a computer, or other programmable apparatus, produces a computer implemented method. The instructions which execute on the computer or other programmable apparatus may provide the mechanism for implementing some or all of the functions/acts specified in the flowchart and/or block diagram block or blocks. In accordance with various implementations, the program code may execute entirely on the user's computer, partly on the user's computer, as a stand-alone software package, partly on the user's computer and partly on a remote computer or entirely on the remote computer or server, such as a cloud-based server. In the latter scenario, the remote computer may be connected to the user's computer through any type of network, including a local area network (LAN) or a wide area network (WAN), or the connection may be made to an external computer (for example, through the Internet using an Internet Service Provider). The computer program code stored in/on (i.e. embodied therewith) the non-transitory computer-readable medium produces an article of manufacture.

The computer program code, if executed by a processor causes physical changes in the electronic devices of the processor which change the physical flow of electrons through the devices. This alters the connections between devices which changes the functionality of the circuit. For example, if two transistors in a processor are wired to perform a multiplexing operation under control of the computer program code, if a first computer instruction is executed, electrons from a first source flow through the first transistor to a destination, but if a different computer instruction is executed, electrons from the first source are blocked from reaching the destination, but electrons from a second source are allowed to flow through the second transistor to the destination. So a processor programmed to perform a task is transformed from what the processor was before being programmed to perform that task, much like a physical plumbing system with different valves can be controlled to change the physical flow of a fluid.

Examples of various embodiments are described in the following paragraphs:

Embodiment 1. A method of creating self-balancing network, the method comprising: establishing a single control point for a software-defined network (SDN), the SDN including one or more network slices and utilizing a first network segment using non-routable IP addresses, a second network segment using routable IP addresses, and a third network segment; adding a first device to a network slice of the one or more network slices of the SDN, the first device coupled to the first network segment; adding a second device to the network slice; obtaining a network policy as a part of a service-level agreement for the network slice; and configuring, by the single control point, at least one of the first network segment, the second network segment, or the third network segment, to enforce the network policy for communication between the first device and the second device.

Embodiment 2. The method of embodiment 1, said configuring comprising configuring, by the single control point, both the second network segment and the first network segment to enforce the network policy for communication between the first device and the second device.

Embodiment 3. The method of embodiment 1 or 2, said configuring comprising configuring, by the single control point, the first network segment and the third network segment to enforce the network policy for communication between the first device and the second device; wherein both the first network segment and the third network segment are coupled to a first port of a gateway device, and the second network segment is coupled to a second port of the gateway device.

Embodiment 4. The method of embodiment 3, said configuring further comprising also configuring, by the single control point, the second network segment to enforce the network policy for communication between the first device and the second device.

Embodiment 5. The method of any of embodiments 1-4, wherein said configuring is done based on one or more of spectrum management of wireless networks utilized by the network slice, fronthaul balancing, or backhaul balancing; the fronthaul comprising one or more fronthaul network segments, including the first network segment, accessible for communication between the first device and a gateway device coupled between the first network segment and the second network segment; and the backhaul including one more backhaul network segments, including the second network segment, accessible for communication between the second device and the gateway device.

Embodiment 6. The method of any of embodiments 1-5, wherein the second device is coupled to the third network segment and the communication between the first device and the second device also traverses the third network segment.

Embodiment 7. The method of any of embodiments 1-6, the first network segment comprising a wireless network hosted by an access point device which is not directly connected to the second network segment, wherein said configuring comprises sending a command to the access point over the second network segment using an IEEE 1905.1 protocol.

Embodiment 8. The method of any of embodiments 1-7, further comprising: receiving a request to add a third device to the network slice, the third device having a capability to connect to the first network segment or the third network segment; analyzing network traffic on the network slice; determining which of the first network segment and third network segment to utilize for the third device based on the network policy and said analyzing; and adding the third device to said determined network segment.

Embodiment 9. The method of any of embodiments 1-8, further comprising: determining that the network slice is unbalanced; and wherein said configuring is based on said determining.

Embodiment 10. The method of embodiment 9, wherein said determining that the network slice is unbalanced comprises receiving an indication that the network policy cannot be enforced for the first device.

Embodiment 11. The method of any of embodiments 1-10, further comprising moving the first device, which is directly connected to the first network segment, to the third network segment.

Embodiment 12. The method of embodiment 11, wherein the first device comprises a first PHY supporting the first network segment and a second PHY, different than the first PHY, supporting the third network segment.

Embodiment 13. The method of embodiment 12, wherein said moved device utilizes a virtualized IP layer to maintain IP connectivity during said moving.

Embodiment 14. The method of any of embodiments 1-13, further comprising moving the first device or a third device, both of which are directly connected to the first network segment, to the third network segment.

Embodiment 15. The method of any of embodiments 1-14, the first network segment comprising a first wireless network operating with a first carrier frequency; and the third network segment comprising a second wireless network operating at a second carrier frequency.

Embodiment 16. The method of any of embodiments 1-15, the first network segment and the third network segment both within a common extended service set hosted by a single access point device.

Embodiment 17. The method of any of embodiments 1-15, the first network segment and the third network segment both within a common extended service set but hosted by two separate access point devices.

Embodiment 18. The method of any of embodiments 1-15, the first network segment and the third network segment in two different extended service sets hosted by a single access point device.

Embodiment 19. The method of any of embodiments 1-15, the first network segment and the third network segment in two different extended service sets hosted by two separate access point devices.

Embodiment 20. The method of any of embodiments 9-19, wherein said determining that the network slice is unbalanced comprises determining that one or more backhaul network segments utilized by the network slice for the communication between the first device and the second device should be reconfigured to support the network policy for the first device; wherein the one or more backhaul network segments, which includes the second network segment, are coupled to a first port of a gateway device, and a second port of the gateway device is coupled to both the first network segment and the first device.

Embodiment 21. The method of any of embodiments 9-20, wherein said determining that the network slice is unbalanced is based on a quality of experience (QoE) calculation.

Embodiment 22. The method of any of embodiments 1-21, wherein said configuring is based on a quality of experience (QoE) calculation for the network slice.

Embodiment 23. The method of any of embodiments 1-22, said configuring comprising: calculating a change to a first QoE calculation based on a particular change to a configuration of the third network segment; determining that the change to the QoE calculation contributes to enforcing the network policy for communication between the first device and the second device; and making the particular change to the configuration of the third network segment.

Embodiment 24. The method of embodiment 23, said configuring further comprising: calculating a change to the first QoE calculation or a second QoE calculation based on a particular change to a configuration of the first network segment; determining that the change to first QoE calculation or the second QoE calculation contributes to enforcing the network policy for communication between the first device and the second device; and making the particular change to the configuration of the first network segment.

Embodiment 25. The method of any of embodiments 1-24, further comprising: monitoring behavior of the first device over time; predicting a future behavior of the first device based on said monitored behavior; wherein said configuring is based on the future behavior.

Embodiment 26. The method of embodiment 25, the future behavior comprising a movement of the first device from the first network segment to a third network segment.

Embodiment 27. The method of any of embodiments 25-26, the future behavior comprising a change in bandwidth used by the first device.

Embodiment 28. The method of any of embodiments 25-27, said predicting performed using an analytic model, machine learning, or a trained neural network.

Embodiment 29. The method of any of embodiments 25-28, said predicting performed using an input to a user interface of the first device by a user.

Embodiment 30. The method of any of embodiments 1-29, further comprising: monitoring behavior of the network slice over time; predicting a future behavior of the network slice based on said monitored behavior; wherein said configuring is based on the future behavior.

Embodiment 31. The method of embodiment 30, said predicting performed using an analytic model, machine learning, or a trained neural network.

Embodiment 32. The method of any of embodiments 1-31, further comprising creating a layer 2 underlay coupling the first network segment with the second network segment.

Embodiment 33. The method of embodiment 32, wherein the layer 2 underlay comprises a QinQ, IPSec, GRE, or L2TPv2 tunnel.

Embodiment 34. The method of any of embodiments 1-33, further comprising creating a virtual extensible LAN overlay for the network slice.

Embodiment 35. At least one non-transitory machine readable medium comprising one or more instructions that in response to being executed on a computing device cause the computing device to carry out a method according to any one of embodiments 1 to 34.

Unless otherwise indicated, all numbers expressing quantities, properties, measurements, and so forth, used in the specification and claims are to be understood as being modified in all instances by the term “about.” The recitation of numerical ranges by endpoints includes all numbers subsumed within that range, including the endpoints (e.g. 1 to 5 includes 1, 2.78, π, 3.33, 4, and 5).

As used in this specification and the appended claims, the singular forms “a”, “an”, and “the” include plural referents unless the content clearly dictates otherwise. Furthermore, as used in this specification and the appended claims, the term “or” is generally employed in its sense including “and/or” unless the content clearly dictates otherwise. As used herein, the term “coupled” includes direct and indirect connections. Moreover, where first and second devices are coupled, intervening devices including active devices may be located there between.

The description of the various embodiments provided above is illustrative in nature and is not intended to limit this disclosure, its application, or uses. Thus, different variations beyond those described herein are intended to be within the scope of embodiments. Such variations are not to be regarded as a departure from the intended scope of this disclosure. As such, the breadth and scope of the present disclosure should not be limited by the above-described exemplary embodiments, but should be defined only in accordance with the following claims and equivalents thereof.

What is claimed is:

1. A method of creating a self-balancing network, the method comprising:
establishing a single control point for a software-defined network (SDN), the SDN including one or more network slices and utilizing a first network segment using non-routable IP addresses, a second network segment using routable IP addresses, and a third network segment;
adding a first device to a network slice of the one or more network slices of the SDN, the first device coupled to the first network segment;
adding a second device to the network slice;
obtaining a network policy as a part of a service-level agreement for the network slice; and
configuring, by the single control point, at least one of the first network segment, the second network segment, or the third network segment, to enforce the network policy for communication between the first device and the second device.

2. The method of claim 1, said configuring comprising configuring, by the single control point, both the second network segment and the first network segment to enforce the network policy for communication between the first device and the second device.

3. The method of claim 1, said configuring comprising configuring, by the single control point, the first network segment and the third network segment to enforce the network policy for communication between the first device and the second device;
wherein both the first network segment and the third network segment are coupled to a first port of a gateway device, and the second network segment is coupled to a second port of the gateway device.

4. The method of claim 3, said configuring further comprising also configuring, by the single control point, the second network segment to enforce the network policy for communication between the first device and the second device.

5. The method of claim 1, wherein said configuring is done based on one or more of spectrum management of wireless networks utilized by the network slice, fronthaul balancing, or backhaul balancing;
the fronthaul comprising one or more fronthaul network segments, including the first network segment, accessible for communication between the first device and a gateway device coupled between the first network segment and the second network segment; and
the backhaul including one more backhaul network segments, including the second network segment, accessible for communication between the second device and the gateway device.

6. The method of claim 1, wherein the second device is coupled to the third network segment and the communication between the first device and the second device also traverses the third network segment.

7. The method of claim 1, the first network segment comprising a wireless network hosted by an access point device which is not directly connected to the second network segment, wherein said configuring comprises sending a command to the access point over the second network segment using an IEEE 1905.1 protocol.

8. The method of claim 1, further comprising:
receiving a request to add a third device to the network slice, the third device having a capability to connect to the first network segment or the third network segment;
analyzing network traffic on the network slice;
determining which of the first network segment and third network segment to utilize for the third device based on the network policy and said analyzing; and
adding the third device to said determined network segment.

9. The method of claim 1, further comprising:
determining that the network slice is unbalanced; and
wherein said configuring is based on said determining.

10. The method of claim 9, wherein said determining that the network slice is unbalanced comprises receiving an indication that the network policy cannot be enforced for the first device.

11. The method of claim 10, further comprising moving the first device, which is directly connected to the first network segment, to the third network segment.

12. The method of claim 11, wherein the first device comprises a first PHY supporting the first network segment and a second PHY, different than the first PHY, supporting the third network segment.

13. The method of claim 12, wherein said moved device utilizes a virtualized IP layer to maintain IP connectivity during said moving.

14. The method of claim 10, further comprising moving the first device or a third device, both of which are directly connected to the first network segment, to the third network segment.

15. The method of claim 14, the first network segment comprising a first wireless network operating with a first carrier frequency; and
the third network segment comprising a second wireless network operating at a second carrier frequency.

16. The method of claim 14, the first network segment and the third network segment both within a common extended service set hosted by a single access point device.

17. The method of claim 14, the first network segment and the third network segment both within a common extended service set but hosted by two separate access point devices.

18. The method of claim 14, the first network segment and the third network segment in two different extended service sets hosted by a single access point device.

19. The method of claim 14, the first network segment and the third network segment in two different extended service sets hosted by two separate access point devices.

20. The method of claim 9, wherein said determining that the network slice is unbalanced comprises determining that one or more backhaul network segments utilized by the network slice for the communication between the first device and the second device should be reconfigured to support the network policy for the first device;
wherein the one or more backhaul network segments, which includes the second network segment, are coupled to a first port of a gateway device, and a second port of the gateway device is coupled to both the first network segment and the first device.

21. The method of claim 9, wherein said determining that the network slice is unbalanced is based on a quality of experience (QoE) calculation.

22. The method of claim 1, wherein said configuring is based on a quality of experience (QoE) calculation for the network slice.

23. The method of claim 1, said configuring comprising:
calculating a change to a first QoE calculation based on a particular change to a configuration of the third network segment;
determining that the change to the QoE calculation contributes to enforcing the network policy for communication between the first device and the second device; and
making the particular change to the configuration of the third network segment.

24. The method of claim 23, said configuring further comprising:
calculating a change to the first QoE calculation or a second QoE calculation based on a particular change to a configuration of the first network segment;
determining that the change to first QoE calculation or the second QoE calculation contributes to enforcing the network policy for communication between the first device and the second device; and
making the particular change to the configuration of the first network segment.

25. The method of claim 1, further comprising:
monitoring behavior of the first device over time; and
predicting a future behavior of the first device based on said monitored behavior;
wherein said configuring is based on the future behavior.

26. The method of claim 25, the future behavior comprising a movement of the first device from the first network segment to a third network segment.

27. The method of claim 25, the future behavior comprising a change in bandwidth used by the first device.

28. The method of claim 25, said predicting performed using an analytic model, machine learning, or a trained neural network.

29. The method of claim 25, said predicting performed using an input to a user interface of the first device by a user.

30. The method of claim 1, further comprising:
monitoring behavior of the network slice over time; and
predicting a future behavior of the network slice based on said monitored behavior;
wherein said configuring is based on the future behavior.

31. The method of claim 30, said predicting performed using an analytic model, machine learning, or a trained neural network.

32. The method of claim 1, further comprising creating a layer 2 underlay coupling the first network segment with the second network segment.

33. The method of claim 32, wherein the layer 2 underlay comprises a QinQ, IPSec, GRE, or L2TPv2 tunnel.

34. The method of claim 1, further comprising creating a virtual extensible LAN overlay for the network slice.

35. At least one non-transitory machine readable medium comprising one or more instructions that in response to being executed on a computing device cause the computing device to carry out a method comprising:
establishing a single control point for a software-defined network (SDN), the SDN including one or more network slices and utilizing a first network segment using non-routable IP addresses, a second network segment using routable IP addresses, and a third network segment;
adding a first device to a network slice of the one or more network slices of the SDN, the first device coupled to the first network segment;
adding a second device to the network slice;
obtaining a network policy as a part of a service-level agreement for the network slice; and
configuring, by the single control point, at least one of the first network segment, the second network segment, or the third network segment, to enforce the network policy for communication between the first device and the second device.
